(19) United States
(12) Patent Application Publication
(10) Pub. No.: US 2011/0119327 A1
(43) Pub. Date: May 19, 2011

(54) System and Method for Efficiently Uploading Data Into A Content Addressable Storage System

(75) Inventor: Ryuji J. Masuda, Los Angeles, CA (US)

(73) Assignee: CASDEX, INC., Camarillo, CA (US)

(21) Appl. No.: 12/619,922

(22) Filed: Nov. 17, 2009

(51) Int. Cl. G06F 15/16

(52) U.S. Cl. 709/203; 709/204; 709/225

(57) ABSTRACT

In one embodiment, a system for efficiently uploading data into a content addressable storage system includes an interface application configured to segment a data object into a plurality of sub-objects, and at least one sub-object datacenter that includes a plurality of sub-object servers. The interface application uploads a stream of sub-objects to the at least one sub-object datacenter over a thread, and if the available bandwidth of that thread is substantially utilized the interface application opens another thread to a sub-object datacenter and uploads another stream of sub-objects. Sub-objects from the same data object can be stored in different sub-object datacenters in different geographic locations. The interface application also generates an object map for the data object that indicates an order of the plurality of sub-objects such that the data object can be reconstructed from its sub-objects.

### FIELD OF THE INVENTION

This invention relates generally to content addressable storage and relates more particularly to a system and method for efficiently uploading data into a content addressable storage system.

### BACKGROUND

Content addressable storage (CAS) is a technique for storing a segment of electronic information that can be retrieved based on its content, not on its storage location. When information is stored in a CAS system, a content identifier is created and linked to the information. The content identifier is then used to retrieve the information. The content identifier is stored with an identifier of where the information is stored. When information is to be stored, a cryptographic algorithm, such as a hash algorithm, is used to create the content identifier that is ideally unique to the information. The content identifier is then compared to a list of content identifiers for information already stored on the system. If the content identifier is found on the list, the information is not stored a second time. Thus a typical CAS system does not store duplicates of information, providing efficient storage. If the content identifier is not already on the list, the information is stored, and the content identifier is stored in a table with the storage location of the information.

Content addressable storage is most commonly used to store information that does not change, such as archived emails, financial records, medical records, and publications. Content addressable storage is highly suited to storing information required by compliance programs because the content can be verified as not having changed. Content addressable storage is also highly suited for storing documents that may need to be produced in litigation discovery. A document that can be produced with a content identifier that was created using a reliable hash algorithm can establish the authenticity of the document. When information is retrieved from a CAS system, a content identifier is provided, and the location corresponding to that content identifier is looked up and the information is retrieved. The content identifier is then recalculated based on the content of the retrieved information and the newly-calculated content identifier is compared to the provided content identifier to verify that the content has not changed.

Some content addressable storage systems are configured to receive information over a wide area network, such as the Internet, for storage. One drawback of such CAS systems is that uploading large data objects over the network typically requires large amounts of bandwidth and/or large amounts of time.

### SUMMARY

In one embodiment, a system for efficiently uploading data into a content addressable storage system includes an interface application configured to segment a data object into a plurality of sub-objects, and at least one sub-object datacenter that includes a plurality of sub-object servers. The interface application uploads a stream of sub-objects to the at least one sub-object datacenter over a thread, and if the available bandwidth of that thread is substantially utilized the interface application opens another thread to a sub-object datacenter and uploads another stream of sub-objects. Sub-objects from the same data object can be stored in different sub-object datacenters in different geographic locations. The interface application also generates an object map for the data object that indicates an order of the plurality of sub-objects such that the data object can be reconstructed from its sub-objects. The object map also includes a unique content identifier for the data object and a unique content identifier for each of the plurality of sub-objects.

In one embodiment, a method for efficiently uploading data into a content addressable storage system includes segmenting a data object into a plurality of sub-objects, uploading at least one of the plurality of sub-objects via a first thread to a first node, and if the available bandwidth of the first thread is substantially utilized, uploading at least one of the plurality of sub-objects via a second thread to a second node. The first node and the second node may be located in separate sub-object datacenters in different geographic locations. The method further includes generating an object map for the data object that includes an order of sub-objects such that the data object can be reconstructed from its plurality of sub-objects. The object map also includes a unique content identifier for the data object and a unique content identifier for each of the plurality of sub-objects.

### BRIEF DESCRIPTION OF THE DRAWINGS

FIG. 1 is a diagram of a network including a content addressable storage system, according to one embodiment of the invention;

FIG. 2 is a diagram of one embodiment of a client in communication with a plurality of sub-object datacenters, according to one embodiment of the invention;

FIG. 3 is a diagram of one embodiment of a data object including sub-objects, according to the invention;

FIG. 4 is a diagram of one embodiment of a data object map, according to the invention;

FIG. 5 is a diagram of a multi-threaded upload to a plurality of lane controller, according to one embodiment of the invention; and

FIG. 6 is a diagram of one embodiment of types of data stored in a content addressable storage system, according to the invention.

### DETAILED DESCRIPTION

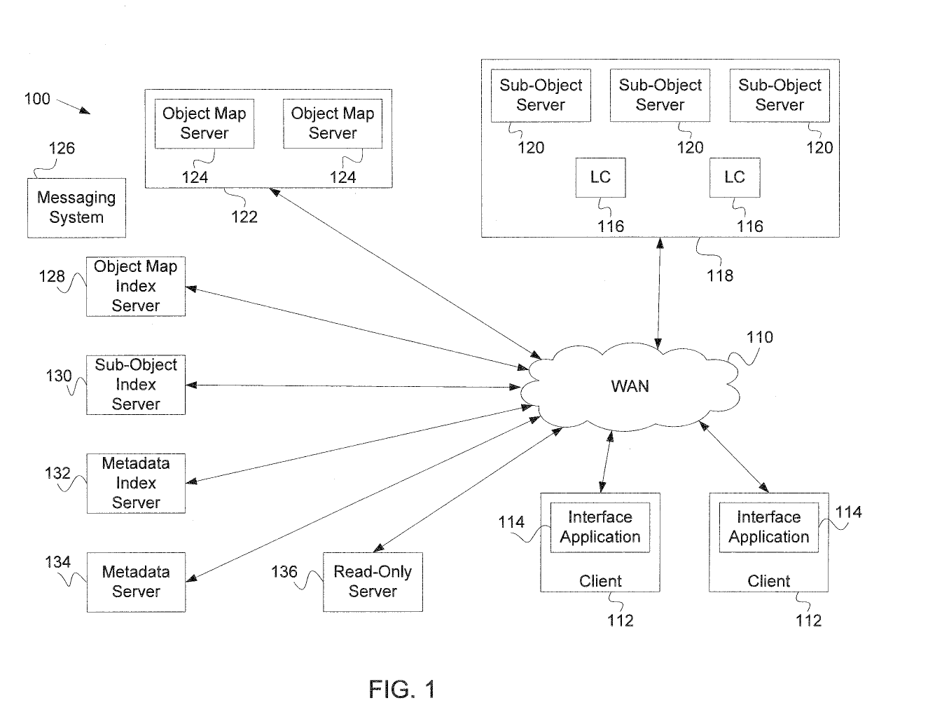

FIG. 1 is a diagram of a network including a content addressable storage (CAS) system 100, according to one embodiment of the invention. Clients 112 are communicatively coupled to a wide area network (WAN) 110. Other types of networks, for example local area networks (LANs) and/or the Internet, and wired and/or wireless networks, are within the scope of the invention. Each client 112 includes an interface application 114. Client 112 may be any type of device configured to communicate over WAN 110, including but not limited to a personal computer, a notebook computer, a netbook computer, a scanner, a proxy server, a handheld computing device, a mobile telephone, or a virtual machine instance. Interface application 114 may be embodied as an interface capable of accepting incoming data objects through programmatic interfaces including but not limited to Application Program Interfaces (APIs), WebServices components, and standardized protocol interfaces including but not limited to Web Distributed Authoring and Versioning (WebDAV), Network File System (NFS), and Hypertext Transport Protocol (HTTP).

In the FIG. 1 embodiment, CAS system 100 includes, but is not limited to, a sub-object datacenter 118, an object map datacenter 122, an object map index server 128, a sub-object index server 130, a metadata index server 132, a metadata server 134, a messaging system 126, and a read-only server 136. Sub-object datacenter 118 includes a plurality of sub-object servers 120 and a plurality of lane controllers (LC) 116. Although only one sub-object datacenter 118 is shown in FIG. 1, CAS system 100 typically includes a plurality of sub-object datacenters 118. Object map datacenter 122 includes a plurality of object map servers 124. Messaging system 126 manages communications, including control messages, between sub-object data center 118, object map datacenter 122, object map index server 128, sub-object index server 130, metadata index server 132, metadata server 134, and read-only server 136. All messages passing through messaging system 126 are logged and stored, which allows for auditing of communications within CAS system 100. Requests for the transmission and retrieval for data objects and related activities such as user accesses to CAS system 100 can all be monitored.

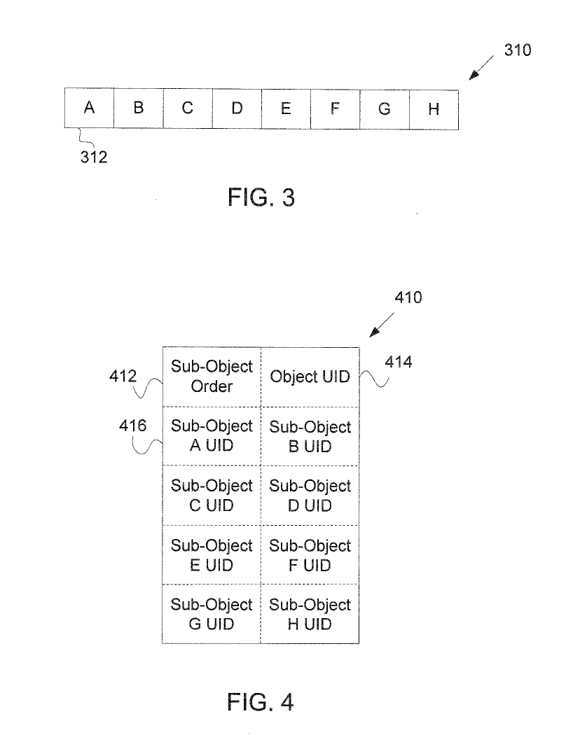

When client 112 wants to store a data object, for example an image file or a word processing document, in CAS system 100, interface application 114 segments the data object into a plurality of sub-objects. FIG. 3 is a diagram of one embodiment of a data object 310 including sub-objects 312, according to the invention. In the FIG. 3 embodiment, data object 310 is segmented into eight sub-objects 312. The size of each sub-object is preferably limited by a maximum size threshold. In one embodiment the maximum size threshold is sixty-four kilobytes, but other maximum size thresholds are within the scope of the invention. Interface application 114 then calculates a unique content identifier for the data object and a unique content identifier for each sub-object using a cryptographic hash algorithm, for example the well-known SHA-1 hash algorithm. Any hash algorithm where the probability of generating identical content identifiers for different data objects using that hash algorithm is below an acceptable threshold is within the scope of the invention.

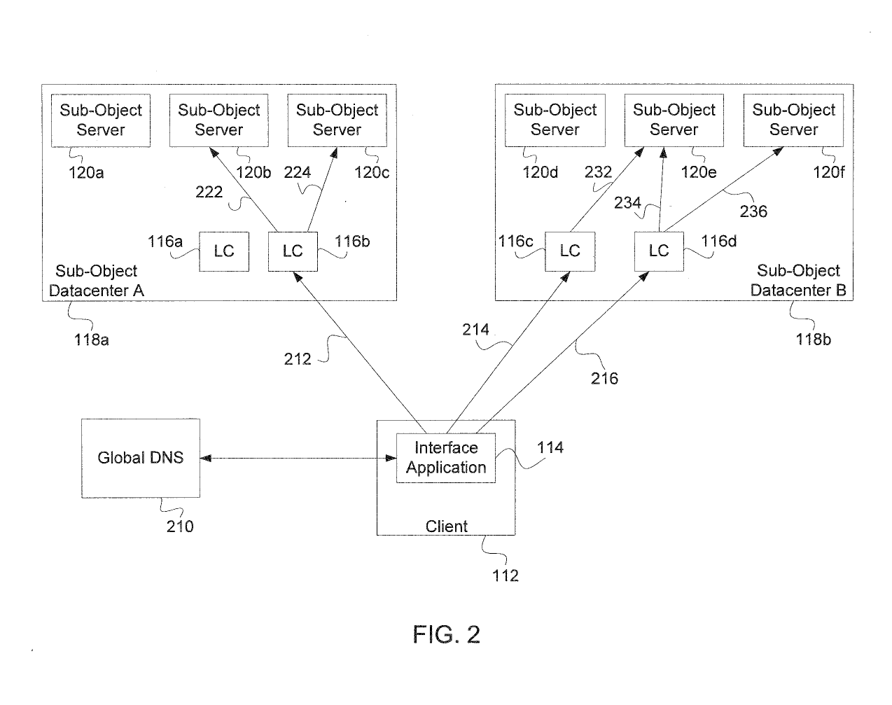

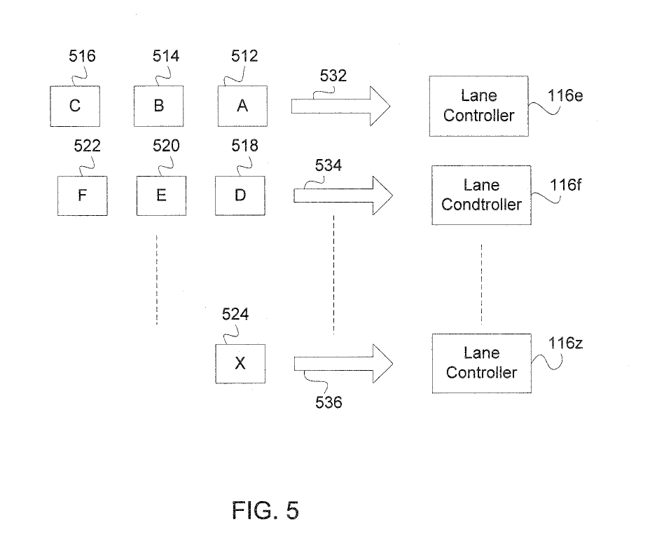

Interface application 114 then creates an object map for the data object. FIG. 4 is a diagram of one embodiment of an object map 410, according to the invention. Object map 410 includes a sub-object order 412 that indicates how the sub-objects are ordered within the data object, which enables the data object to be correctly reconstructed from its sub-objects. Object map 410 also includes a data object unique identifier (UID) 414 and unique identifiers for each of the sub-objects, for example sub-object A UID 416. Interface application 114 sends the object map to sub-object index server 130, which determines whether any of the sub-objects have been previously stored in CAS system 100 based on the sub-object unique identifiers in the object map. Sub-object index server 130 sends a message to interface application 114 indicating, which, if any, of the sub-objects have not previously been stored in CAS system 100. Interface application 114 then uploads the sub-objects that have not been previously stored to one or more of the sub-object datacenters 118 via WAN 110 using a multi-thread technique, which is described below in conjunction with FIGS. 2 and 5.

If the data object is another version of a data object that had been previously stored in CAS system 100, one or more sub-objects of the data object may already be stored in CAS system 100. If the new version of the data object is only slightly different than the older version of the data object, only a few of its sub-objects may need to be uploaded to a sub-object server 120. Uploading only the sub-objects that are different from the sub-objects of a previous version of a data object is more efficient than uploading an entire data object. Although fewer than all of a data object's sub-objects may be uploaded to a sub-object datacenter, the object map for the data object includes a sub-object unique identifier for each of the data object's sub-objects such that the entire data object can be reconstructed, and also includes a data object unique identifier that uniquely identifies that data object even though it may have some sub-objects in common with another data object stored in CAS system 100.

When sub-object datacenter 118 receives a sub-object from client 112, sub-object datacenter 118 calculates an identifier for the sub-object using the same hash algorithm used by interface application 114. Sub-object datacenter 118 sends this identifier back to interface application 114, which compares the received identifier with the sub-object unique identifier it calculated for the sub-object. If the two unique identifiers match, interface application 114 sends a confirmation to sub-object datacenter 118. Sub-object datacenter 118 then creates a sub-object index that includes the sub-object's unique identifier and storage location, and sends the sub-object index to sub-object index server 130. If the two unique identifiers do not match, interface application 114 assumes that a transmission error occurred and re-uploads the sub-object to sub-object datacenter 118. If sub-object datacenter 118 does not receive a confirmation for a sub-object, the location where that sub-object is stored is marked as available and another sub-object may be stored in that location.

In another embodiment, sub-object datacenter 118 compares the identifier it calculated for the sub-object with the list of sub-object identifiers in the object map. If the calculated sub-object identifier appears on the list, sub-object datacenter 118 sends a confirmation to interface application 114 and send a sub-object index for that sub-object to sub-object index server 130. If the calculated sub-object identifier does not appear on the list, sub-object datacenter 118 requests re-transmission of the sub-object from interface application 114.

Once all the sub-objects have been successfully uploaded to one or more sub-object datacenters 118, interface application 114 sends the object map for the data object to an object map datacenter 122, which calculates an unique identifier for the object map and stores the object map and its unique identifier in one of the object map servers 124. Object map datacenter 122 then creates an object map index that includes the object map's unique identifier and storage location, and sends the object map index to object map index server 128 for storage.

Interface application 114 also creates a metadata object that includes the metadata of the data object. The metadata includes the data object's unique identifier and any other metadata such as filename, file size, creation date, etc. The metadata object includes the metadata for the data object and a metadata unique identifier created by applying the hash algorithm to the metadata. Interface application 114 sends the metadata object to metadata server 134, which stores the metadata object and creates a metadata index that includes the metadata's unique identifier and storage location. Metadata server 134 sends the metadata index to metadata index server 132 for storage.

Data objects stored in CAS system 100 may be retrieved based on the metadata for the data object. Interface application 114 sends metadata, for example a filename, for a data object to metadata server 134, which retrieves the data object identifier associated with that metadata. Metadata server 134 sends the data object identifier to object map datacenter 122, which retrieves the object map that includes the data object identifier. Object map datacenter 122 then sends the sub-object identifiers in the object map to sub-object index server 130 to retrieve the storage location of each of the sub-objects of the data object. Sub-object index server 130 sends the object map and the storage locations for each of the sub-objects to interface application 114. Interface application 114 downloads each sub-object from the sub-object server 120 where it is stored, and then uses the object map to reconstruct the data object from its sub-objects. Interface application 114 then integrates the metadata into the data object and outputs the data object to client 112.

Read-only server 136 operates as a cache for sub-objects. Sub-objects that are frequently requested for download from CAS system 100 to a client 112 may be stored in read-only server 136. Read-only server 136 stores copies of sub-objects that have been previously stored in a sub-object datacenter 118, and clients 112 are not able to upload sub-objects to read-only server 136. Downloading sub-objects from read-only server 136 may be faster than downloading sub-objects from one or more sub-object datacenters 118 because read-only server 136 is not subject to uploading traffic.

FIG. 2 is a diagram of one embodiment of a client in communication with a plurality of sub-object datacenters 118, according to one embodiment of the invention. Each of sub-object datacenters 118a and 118b includes a plurality of lane controllers (LC) 116 and a plurality of sub-object servers 120. When a client wishes to upload a data object to the CAS system, interface application 114 communicates with a global domain name service (DNS) system 210, which uses well-known domain name service and load balancing techniques to identify a lane controller 116 to receive sub-objects from interface application 114. In the FIG. 2 embodiment, global DNS 210 initially directs interface application 114 to a lane controller 116b in sub-object datacenter A 118a by sending an identifier such as an IP address for lane controller 116b to interface application 114. Interface application 114 then opens a communication thread 212 to lane controller 116b and begins uploading sub-objects to lane controller 116b. Lane controller 116b receives the sub-objects and decides in which of the sub-object servers 120 to store each sub-object. In the FIG. 2 embodiment, one or more of the sub-objects received by lane controller 116b are stored in sub-object server 120b via a path 222 and one or more of the sub-objects are stored in sub-object server 120c via a path 224. Lane controller 116b decides where to store each received sub-object based on system resources of sub-object servers 120a-120c including but not limited to processing power, memory size, and data storage availability.

Interface application 114 sends a stream of sub-objects to lane controller 116b over thread 212, adding sub-objects to the stream until the available bandwidth over thread 212 is substantially utilized. If additional sub-objects are to be stored in the CAS system, interface application 114 communicates with global DNS 210 to obtain an IP address for another lane controller 116. In the FIG. 2 embodiment, global DNS 210 directs interface application 114 to lane controller 116c in sub-object datacenter B 118b. Interface application 114 then opens another communication thread 214 to lane controller 116c and begins uploading sub-objects to lane controller 116c. Lane controller 116c receives the sub-objects and decides in which of the sub-object servers 120 to store each sub-object. In the FIG. 2 embodiment, each of the sub-objects received by lane controller 116c from interface application 114 is stored in sub-object server 120e via a path 232.

If both threads 212 and 214 are being used to capacity to upload sub-objects and further sub-objects remain to be uploaded, interface application 114 again communicates with global DNS 210 to obtain an IP address for another lane controller 116. In the FIG. 2 embodiment, global DNS 210 directs interface application 114 to lane controller 116d in sub-object datacenter B 118b. Interface application 114 opens another communication thread 216 to lane controller 116d and begins uploading sub-objects to lane controller 116d. Lane controller 116d receives the sub-objects and decides in which of the sub-object servers 120 to store each sub-object. In the FIG. 2 embodiment, one or more of the sub-objects received by lane controller 116d are stored in sub-object server 120e via a path 234 and one or more of the sub-objects are stored in sub-object server 120f via a path 236. Interface application 114 opens an initial thread to begin an upload, and then opens additional threads until it no longer sees an increase in performance of the upload, up to a user-specified maximum number of threads.

Each of lane controllers 116b, 116c, and 116d calculates a sub-object unique identifier for each sub-object it receives and sends the sub-object unique identifier to interface application 114. If a lane controller 116 receives a confirmation or acknowledgement message back from interface application 114, lane controller 116 sends the sub-object index (the sub-object's unique identifier and storage location) to sub-object index server 130. Thus each sub-object is stored in a sub-object server 120 before the sub-object is authenticated, but the storage location of the sub-object is only confirmed (by storing the sub-object index) after the sub-object has been authenticated by interface application 114. In another embodiment, each of lane controllers 116b, 116c, and 116d authenticates the transmission of each sub-object it receives by comparing a sub-object identifier calculated for that sub-object with a sub-object identifier received from interface application 114.

Interface application 114 is able to simultaneously upload streams of sub-objects over multiple threads to multiple lane controllers 116 in such a way that the available bandwidth over each thread is optimally utilized. By uploading streams of sub-objects in parallel over multiple threads, interface application 114 is able to quickly upload large data objects to the CAS system.

Sub-object datacenter A 118a and sub-object datacenter B 118b may be in different geographical locations. For example, sub-object datacenter A 118a may be located in the United States while sub-object datacenter B 118b may be located in Europe. Thus the sub-objects of a given data object may not only be stored in different sub-object servers 120 within the same sub-object datacenter 118, but may be stored in different sub-object datacenters 118 in different parts of the world. Such dispersed sub-objects can be collected together to reconstruct the data object because an object map for the data object that includes the unique identifiers for all sub-objects of that data object is stored in object map server 124 and the storage location for each sub-object is stored in sub-object index server 130.

FIG. 5 is a diagram of a multi-threaded upload to a plurality of lane controllers 116, according to one embodiment of the invention. A data object having a plurality of sub-objects A through X is being stored in CAS system 100 via a plurality of lane controllers 116. Sub-object A 512, sub-object B 514, and sub-object C 516 are being uploaded via a thread 532 to a lane controller 116e. The bandwidth available on thread 532 is being used to capacity, so another thread 534 is opened to lane controller 116f. Sub-object D 518, sub-object E 520, and sub-object F 522 are being uploaded via thread 534 to lane controller 116f. As the bandwidth available for each thread is being used to capacity additional threads are opened to additional lane controllers 116. In the FIG. 5 embodiment, sub-object X 524 is the final sub-object to be uploaded and is uploaded via a thread 536 to a lane controller 116z.

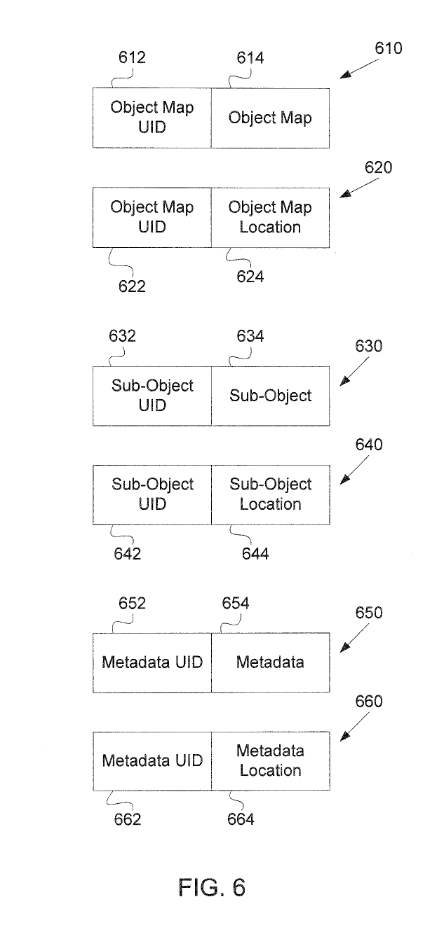

FIG. 6 is a diagram of one embodiment of types of data stored in a content addressable storage system, according to the invention. A type of data unit 610 stored in object map server 124 includes an object map 614 and an object map unique identifier 612 for object map 614. A type of data unit 620 stored by object map index server 128 includes an object map unique identifier 622 and an object map location 624. When object map unique identifier 612 and object map unique identifier 622 have the same value, object map location 624 indicates the storage location of object map 614.

A type of data unit 630 stored in sub-object server 120 includes a sub-object 634 and a sub-object unique identifier 632 for sub-object 634. A type of data unit 640 stored in sub-object index server 130 includes a sub-object unique identifier 642 and a sub-object location 644. When sub-object unique identifier 632 and sub-object unique identifier 642 have the same value, sub-object location 644 indicates the storage location of sub-object 634.

A metadata object 650 stored in metadata server 134 includes metadata 654 and a metadata unique identifier 652 for metadata 654. Although not shown in FIG. 6, metadata 654 includes the data object unique identifier for a data object. A type of data unit 660 stored in metadata index server 132 includes a metadata unique identifier 662 and a metadata location 664. When metadata unique identifier 652 and metadata unique identifier 662 have the same value, metadata location 664 indicates the storage location of metadata 654.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method comprising:
segmenting a data object into a plurality of sub-objects;
uploading at least one of the plurality of sub-objects via a first thread to a first node; and
if available bandwidth of the first thread is substantially utilized, uploading at least one of the plurality of sub-objects via a second thread to a second node.

2. The method of claim 1, further comprising:
if available bandwidth of the second thread is substantially utilized, uploading at least one of the plurality of sub-objects via a third thread to a third node.

3. The method of claim 1, wherein the first node is located in a first datacenter and the second node is located in a second datacenter.

4. The method of claim 1, wherein each of the plurality of sub-objects is no larger than sixty-four kilobytes.

5. The method of claim 1, further comprising generating a unique content identifier for the data object and for each of the plurality of sub-objects.

6. The method of claim 1, further comprising:
generating an object map that indicates an order of sub-objects to enable the data object to be reconstructed from the plurality of sub-objects.

7. The method of claim 6, wherein the object map includes a unique content identifier for the data object and a unique content identifier for each of the plurality of sub-objects.

8. A system comprising:
an interface application configured to segment a data object into a plurality of sub-objects; and
at least one sub-object datacenter that includes at least one lane controller and a plurality of sub-object servers,
the interface application further configured to upload at least one of the plurality of sub-objects over a first thread to the at least one lane controller, and if available bandwidth of the first thread is substantially utilized, to upload at least one other of the plurality of sub-objects over a second thread to another lane controller.

9. The system of claim 8, wherein the other lane controller is located within the at least one sub-object datacenter.

10. The system of claim 8, wherein the other lane controller is located within a second sub-object datacenter.

11. The system of claim 8, wherein the interface application is further configured to generate an object map that indicates an order of sub-objects to enable the data object to be reconstructed from the plurality of sub-objects.

12. The system of claim 11, further comprising an object map datacenter configured to receive the object map from the interface application.

13. The system of claim 8, wherein the interface application is further configured to generate a unique content identifier for the data object and a unique content identifier for each of the plurality of sub-objects.

14. The system of claim 8, wherein the at least one lane controller is configured to store a received sub-object in one of the plurality of sub-object servers.

15. A system comprising:
a plurality of sub-object datacenters, each sub-object datacenter including a plurality of lane controllers and a plurality of sub-object servers, each of the plurality of lane controllers configured to determine a sub-object server within its sub-object datacenter in which to store a received sub-object; and
an interface application configured to segment a data object into a plurality of sub-objects and to upload the plurality of sub-objects to one or more lane controllers via at least two threads in such a way that the entire plurality of sub-objects is not stored in the same sub-object server.

16. The system of claim 15, wherein the interface application is further configured to generate an object map that indicates an order of sub-objects to enable the data object to be reconstructed from the plurality of sub-objects.

17. The system of claim 16, further comprising an object map datacenter configured to receive the object map from the interface application.

18. The system of claim 15, wherein the interface application is further configured to calculate a unique content identifier for the data object and a unique content identifier for each of the plurality of sub-objects.

19. The system of claim 15, wherein each of the plurality of lane controllers selects a sub-object server in which to store a sub-object based on available resources of the plurality of sub-object servers.

20. The system of claim 15, wherein each of the plurality of sub-objects is no larger than sixty-four kilobytes.
